(19) United States
(12) Patent Application Publication
(10) Pub. No.: US 2011/0035124 A1
(43) Pub. Date: Feb. 10, 2011

(54) METHOD OF OPERATING AN AUTOMATIC TRANSMISSION AS WELL AS CONTROLLER

(75) Inventors: Martin GENTILE, Ruesselsheim (DE); Gernot BECKER, Mainz (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/835,177

(22) Filed: Jul. 13, 2010

(30) Foreign Application Priority Data
Jul. 17, 2009 (GB) 0912418.1

(51) Int. Cl. F16H 59/18; F16H 61/10

(52) U.S. Cl. 701/58

(57) ABSTRACT

A method is provided for operating an automatic transmission for a vehicle, that includes, but is not limited to detecting whether a target speed of the vehicle is set, calculating an optimum acceleration gear in dependence of an actual virtual accelerator pedal position, and, if the optimum acceleration gear differs from a current gear, storing the actual virtual accelerator pedal position, shifting to the optimum acceleration gear and ignoring newly calculated actual virtual accelerator pedal positions for an acceleration period of time. Since the actual virtual accelerator pedal position is stored in the case of a detected necessary gear shift and further calculated actual virtual accelerator pedal positions are ignored for a time, the operating of the transmission is based mainly on the value of the actual virtual accelerator pedal position at the time, when a necessary gear shift is detected. The risk that due to insignificant changes of the accelerator pedal position the gear is shifted up and down several times (“gear hunting”) until the target speed is reached is reduced.

### CROSS-REFERENCE TO RELATED APPLICATION

This application claims priority to British Patent Application No. 0912418.1, filed Jul. 17, 2009, which is incorporated herein by reference in its entirety.

### TECHNICAL FIELD

The invention relates to a method of operating an automatic transmission for a vehicle as well as a controller for carrying out such kind of an operating method.

### BACKGROUND

From DE 100 65 368 A1 a method of operating an automatic transmission for a vehicle is known, by which the angle of a throttle valve is controlled for keeping a set target speed constant (“cruise control”).

It is a disadvantage of such kind of an operating method that in the case of initiating the cruise control for keeping a set target speed constant and/or a changed target speed is selected it is possible that the gear is shifted up and down several times (“gear hunting”) until the target speed is reached.

It is at least one object of the invention to provide a method of operating an automatic transmission for a vehicle as well as a controller, by which the risk of gear hunting is reduced. Furthermore, other objects, desirable features, and characteristics will become apparent from the subsequent summary and detailed description, and the appended claims, taken in conjunction with the accompanying drawings and this background.

### SUMMARY

The solution of the at least one object, other objects, desirable features, and characteristics, are achieved by a method for operating an automatic transmission for a vehicle and a controller for operating an automatic transmission for a vehicle, particularly for carrying out the method.

The method according to an embodiment of the invention is adapted for operating an automatic transmission for a vehicle. In accordance with this method, it is detected whether a target speed of the vehicle is set. An optimum acceleration gear in dependence of an actual virtual accelerator pedal position is calculated. If the optimum acceleration gear differs from a current gear, the actual virtual accelerator pedal position is stored, it is shifted to the optimum acceleration gear and newly calculated actual virtual accelerator pedal positions are ignored for an acceleration period of time.

Since the actual virtual accelerator pedal position is stored in the case of a detected necessary gear shift and further calculated actual virtual accelerator pedal positions are ignored for a time, the operating of the transmission is based mainly on the value of the actual virtual accelerator pedal position at the time, when a necessary gear shift is detected. The actual virtual accelerator pedal position is particularly the main parameter for controlling the transmission, so that mainly most corrective actions regarding the automatic transmission are based on this parameter and/or a parameter equivalent to the actual virtual accelerator pedal positions, like the angle of a throttle valve. A change of the actual virtual accelerator pedal position after the gear shift has no impact to the operation of the transmission as long as the acceleration period is present and not terminated. The risk that due to calculation errors and/or an insignificant change of the acceleration pedal by the driver the gear shifts back is prevented at least until the acceleration period terminates. The risk that the gear is shifted up and down several times (“gear hunting”) until the target speed is reached is reduced. This increases in addition the comfort to the driver. The acceleration may be a positive acceleration, this means speeding up, and/or a negative acceleration, this means slowing down.

In addition a further gear hunting situation is prevented. When for example a down shift is initiated during cruise control a higher positive acceleration can be provided in a lower gear. In order to provide a mainly constant acceleration the actual virtual accelerator pedal position is corrected to a lower acceleration position. Based on this newly calculated actual virtual accelerator pedal position the cruise control may initiate an up shift and a further down shift after another calculation of the actual virtual accelerator pedal position in the higher gear an so on. By freezing the old actual virtual accelerator pedal position at the time of initiating a gear shift the newly calculated actual virtual accelerator pedal position is ignored and no gear shift back can be initiated by the newly calculated value of the actual virtual accelerator pedal position. After a comparatively short period of time the operating region for the engine, where a gear hunting would be likely, is passed and the acceleration period, during which the newly calculated values of the actual virtual accelerator pedal position are ignored, can be terminated. After the termination of the acceleration period the control goes back from such a gear shift mode to a normal cruise control mode, where gear shifts due to the small differences between the actual speed and the target speed are not necessary and gear hunting does not occur.

Preferably the acceleration period terminates, when the target speed is reached and/or a maximum period of time is reached. After reaching the target speed further differences between the actual speed and the target speed are so small that shifting a gear is not necessary and gear hunting does not occur. If so, the acceleration period can be terminated sooner, particularly at a time, when based on internal calculations of the transmission operating control the risk of gear hunting is estimated low. For instance a maximum period of time is set, which may be different in dependence of the target speed and/or the current gear and/or the calculated optimum acceleration gear. The maximum period of time can be a kind of time-out for terminating the acceleration period of the gear shift mode particularly before the driver can get an unsafe feeling about his ignored acceleration pedal positions.

Particularly the steps of calculating the optimum acceleration gear, shifting to the optimum acceleration gear and ignoring newly calculated actual virtual accelerator pedal positions are repeated. Particularly the step of storing the actual virtual accelerator pedal position is repeated as well. By the repetition of these steps it is possible allowing more than one gear shift in one direction. For instance it is possible to allow a down shift by two gears in the case of a comparatively high wanted acceleration. Since it is stored still the same value of the actual virtual accelerator pedal position it is at the same time even possible to shift one gear back without the risk of gear hunting. Thus, an optimized gear shift strategy of shifting several gears up and down can be performed without increasing the risk of gear hunting.

In a preferred embodiment the actual virtual accelerator pedal position is calculated by considering the actual acceleration of the vehicle and/or the actual pedal position and/or the actual torque of the transmission and/or the actual speed of the vehicle and/or the torque characteristic of the transmission. By the use of these parameters it is for example possible to take into account driving situations like driving a hill up or down and/or low or high loads like a trailer coupled to the vehicle. Thus, it is possible to take into account that an actual pedal position usually used for a high acceleration does not mean a wanted high acceleration in the case of high loads and a high weight. Based on these parameters the actual pedal position can be translated to an actual virtual accelerator pedal position at predefined normal driving conditions, like a particular defined weight and a planar road.

Particularly, an optimum driving gear of the transmission in dependence of the target speed is calculated and, when the target speed is reached, the optimum driving gear is shifted, if the optimum driving gear differs from the current gear. By this step it is taken into account that for reaching the target speed a current gear may be chosen with respect to sufficient positive or negative acceleration. But the optimum driving gear may be chosen with respect to low fuel consumption, which is usually a very high gear with a low acceleration behavior, since a fast acceleration is not needed, when the target speed of the cruise control is reached. Thus, a fast reaching of a wanted target speed is possible without significantly increasing the CO2 emission of the engine.

Most preferred the target speed and/or the actual speed and/or the actual virtual accelerator pedal position and/or the current gear are provided by a CAN-bus. The CAN-bus of a CAN (“controller area network”) may connect a plurality of vehicle aggregates and provides the parameter of the aggregates to other aggregates. By means of the CAN-bus actual data of the engine like power, torque, speed, current gear and so on can be collected by the transmission control. This in turn leads to the effect that a cruise control is performed by the transmission control itself without an additional separate control unit for the cruise control. In the case of an activated cruise control the cruise control forming part of the transmission control can overrule other calculated transmission control commands of the other parts of the transmission control. Contrary control commands or actions can easily be prevented.

A controller is also provided in accordance with an embodiment of the invention for operating an automatic transmission for a vehicle, particularly for carrying out the method as previously described. The method comprises a switch element for initiating a control routine for reaching a set target speed, an information input for receiving data about an actual virtual accelerator pedal position and a current gear, a calculation unit for calculating an optimum acceleration gear in dependence of the actual virtual accelerator pedal position, and a steering output for initiating a gear shift to the optimum acceleration gear, if the optimum acceleration gear differs from a current gear. Since the actual virtual accelerator pedal position is stored in the case of a detected necessary gear shift and further calculated actual virtual accelerator pedal positions are ignored for a time, the operating of the transmission is based mainly on the value of the actual virtual accelerator pedal position at the time, when a necessary gear shift is detected. The risk that due to insignificant changes of the accelerator pedal position the gear is shifted up and down several times (“gear hunting”) until the target speed is reached is reduced.

Particularly, a storing unit for storing the actual virtual accelerator pedal position is provided. The storing unit is preferably a local memory, which can only be written by the controller. Since no other device can change the stored data a secure freezing of the stored actual virtual accelerator pedal position is safeguarded. Particularly the value of the actual virtual accelerator pedal position is only derived from the storing unit for all calculation processes of the controller. During the acceleration period, when newly calculated actual virtual accelerator pedal positions are ignored, the storing unit may simply be set to write protection. By means of a simple software setting the previously described method can be performed without significant changes to the controller hardware.

Preferably the information input is connected to a CAN-bus interface for connecting the information input to a CAN-bus. By means of the CAN-bus actual data of the engine like power, torque, speed, current gear and so on can be collected by the transmission control.

### BRIEF DESCRIPTION OF THE DRAWINGS

The present invention will hereinafter be described in conjunction with the following drawing FIGURE

FIG. 1 is a schematic flowchart of an operating method in accordance with an embodiment of the invention.

### DETAILED DESCRIPTION

The following detailed description is merely exemplary in nature and is not intended to limit application and uses. Furthermore, there is no intention to be bound by any theory presented in the preceding background or summary or the following detailed description.

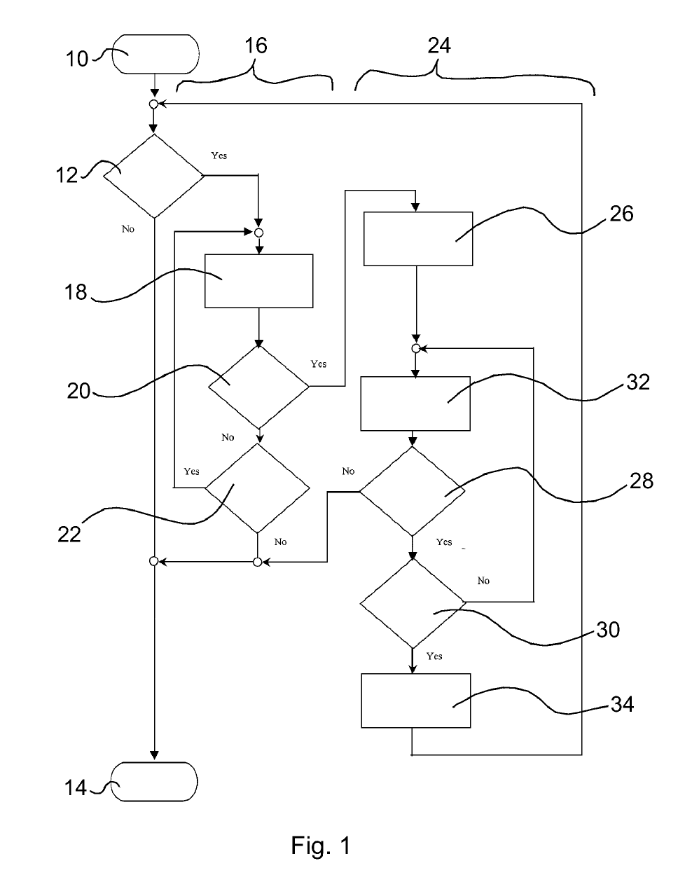

As illustrated in FIG. 1, the method for operating an automatic transmission for a vehicle starts at a start 10. After the start 10 it is checked in a step 12, whether a cruise control is active. If not, the method ends at an end 14. If no cruise control is activated by the driver the cruise control method does not take place. If the cruise control is activated, a normal cruise control mode 16 is initiated. In the normal cruise control mode 16 data about a set target speed as well as an actual virtual accelerator pedal position is transferred to a transmission control in step 18. After this an optimum acceleration gear is calculated on the basis of the collected data. Then in step 20 it is checked whether a gear shift is necessary. If not, it is checked in step 22, whether the cruise control is still active. If not, the method ends at end 14, else step 18 and step 20 are repeated for collecting a further time actual data about the target speed and the actual virtual accelerator pedal position and checking again, whether a gear shift is necessary.

In the case that in step 20 a gear shift is regarded as being necessary, the transmission control changes from normal cruise control mode 16 to a special gear shift mode 24. In the gear shift mode 24 first in step 26 the actual virtual accelerator pedal position is stored and the detected necessary gear shift is performed. The stored actual virtual accelerator pedal position is used for all subsequent processes in the gear shift mode 24, since a newly calculated actual virtual accelerator pedal position is ignored.

After freezing the actual virtual accelerator pedal position it is checked in step 28, whether the cruise control is still active. If not, the method ends at end 14, else it is checked in the step 30, whether the target speed is reached. If not, step 28 and step 30 repeated. If so, a further step 32 can be repeated, by which is checked whether an additional gear shift is necessary. For example in step 26 the gear is down shifted by two gears for providing a very fast acceleration for reaching a high target speed. In such kind of a situation an intermediate up shift by one gear in step 32 can be favorable until the intended target speed is reached.

When the check of step 30 comes to the conclusion that within a predefined tolerance band the target speed is reached, in step 34 an optimum driving gear for the reached target speed is set, if not already set by step 26 or step 32. Further the ignoring of the actual virtual accelerator pedal position is terminated and the newly calculated values of the actual virtual accelerator pedal position are used for the subsequent processes. After step 34 the transmission control changes from the gear shift mode 24 back to the normal cruise control mode 16 by proceeding at step 12.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for operating an automatic transmission for a vehicle, comprising:
detecting whether a target speed of the vehicle is set;
calculating an optimum acceleration gear in dependence of an actual virtual accelerator pedal position; and
if the optimum acceleration gear differs from a current gear, storing the actual virtual accelerator pedal position, shifting to the optimum acceleration gear, and ignoring newly calculated actual virtual accelerator pedal positions for an acceleration period.

2. The method according to claim 1, wherein the acceleration period terminates, when reaching the target speed is reached and/or a maximum period of time is reached.

3. The method according to claim 1, wherein the acceleration period terminates, when reaching a maximum period of time.

4. The method according to claim 1, further comprising the step of repeating the calculating the optimum acceleration gear, shifting to the optimum acceleration gear, and ignoring newly calculated actual virtual accelerator pedal positions.

5. The method according to claim 1, wherein an actual virtual accelerator pedals position is calculated by considering an actual acceleration of the vehicle.

6. The method according to claim 1, wherein the actual virtual accelerator pedal position is calculated by considering an actual pedal position.

7. The method according to claim 1, wherein the actual virtual accelerator pedal position is calculated by considering an actual torque of the transmission.

8. The method according to claim 1, wherein the actual virtual accelerator pedal position is calculated by considering an actual speed of the vehicle.

9. The method according to claim 1, wherein the actual virtual accelerator pedal position is calculated by considering a torque characteristic of the transmission.

10. The method according to claim 1, further comprising calculating an optimum driving gear of the transmission in dependence of the target speed and, when the target speed is reached, the optimum driving gear is shifted if the optimum driving gear differs from the current gear.

11. The method according to claim 1, wherein the target speed is provided by a CAN-bus.

12. The method according to claim 1, wherein an actual speed is provided by a CAN-bus.

13. The method according to claim 1, wherein the actual virtual accelerator pedal position is provided by a CAN-bus.

14. The method according to claim 1, wherein the current gear is provided by a CAN-bus.

15. A controller for operating an automatic transmission for a vehicle, comprising:
a switch element for initiating a control routine for reaching a set target speed;
an information input for receiving data about an actual virtual accelerator pedal position and a current gear;
a calculation unit for calculating an optimum acceleration gear in dependence of the actual virtual accelerator pedal position; and
a steering output for initiating a gear shift to the optimum acceleration gear, if the optimum acceleration gear differs from the current gear.

16. The controller according to claim 15, further comprising a storing unit for storing the actual virtual accelerator pedal position.

17. The controller according to claim 15, wherein the information input is connected to a CAN-bus interface for connecting the information input to a CAN-bus.
